(19) United States
(12) Patent Application Publication
(10) Pub. No.: US 2001/0005845 A1
(43) Pub. Date: Jun. 28, 2001

(54) Electronic advertisement receiving apparatus, electronic advertisement confirming apparatus and electronic advertisement supply system for enabling advertiser to know without inquiry user confirmation of distributed electronic advertisement contents

(76) Inventor: Yoriko Azuma, Soraku-gun (JP)

Correspondence Address: BIRCH, STEWART, KOLASCH & BIRCH, LLP, P.O. Box 747, Falls Church, VA, 22040-0747, US

(21) Appl. No.: 09/747,982

(22) Filed: Dec. 27, 2000

(30) Foreign Application Priority Data
Dec. 27, 1999 (JP) 11-369295(P)
Dec. 6, 2000 (JP) 2000-371659(P)

(51) Int. Cl. G06F 7/00

(52) U.S. Cl. 707/1

(57) ABSTRACT

An advertiser distributes an electronic advertisement to an electronic advertisement receiving apparatus of a user via an electronic advertisement distribution apparatus of an ad agency. The electronic advertisement receiving apparatus presents ad information on the distributed electronic advertisement by means of an image or speech as desired by the user. A reproduction stamp representing this presentation is generated correspondingly to that electronic advertisement and informed to an electronic advertisement confirming apparatus of the advertiser. The advertiser can accordingly know without inquiry, when the reproduction stamp is informed, that the ad information of the electronic advertisement corresponding to the reproduction stamp is confirmed by the user.

### BACKGROUND OF THE INVENTION

1. Field of the Invention

The present invention relates to an electronic advertisement receiving apparatus, an electronic advertisement confirming apparatus and an electronic advertisement supply system. In particular, the invention relates to an electronic advertisement receiving apparatus, an electronic advertisement confirming apparatus and an electronic advertisement supply system to enable an advertiser to know without inquiry that a user has confirmed contents of a distributed electronic advertisement.

2. Description of the Background Art

Advertisers supplying information about contents of advertisements (hereinafter referred to as advertisement (ad) information) have generally distributed the ad information such as bargain sale at supermarkets and discount at restaurants to general public by distributing leaflets having such ad information printed on papers to be folded and inserted between folded newspapers or distributing leaflets to pedestrians on the street. However, such a method of distributing ad information by means of papers has a problem that printing and labor cost is too great for distributing ad information by means of papers over a large area.

Japanese Patent Laying-Open No. 11-66038 discloses an information providing system to overcome such a problem. By this information providing system, various information like ad information can electronically be distributed to an unspecified number of people. However, this information providing system merely allows one-way distribution of ad information from advertisers to users. The advertisers therefore cannot know if the users have confirmed contents of the ad information nor ascertain advertising effects by distribution of the ad information.

### SUMMARY OF THE INVENTION

One object of the present invention is to provide an electronic advertisement receiving apparatus, an electronic advertisement confirming apparatus and an electronic advertisement supply system capable of proving that a user has confirmed distributed advertisement information.

Another object of the invention is to provide an electronic advertisement receiving apparatus, an electronic advertisement confirming apparatus and an electronic advertisement supply system enabling an advertiser to know that a user has confirmed distributed ad information.

Still another object of the present invention is to provide an electronic advertisement receiving apparatus, an electronic advertisement confirming apparatus and an electronic advertisement supply system enabling a user to gain benefits from an advertiser in return for confirmation of distributed ad information.

An electronic advertisement receiving apparatus according to one aspect of the invention for accomplishing these objects includes an electronic advertisement receiving unit for receiving an electronic advertisement including advertisement information, a presenting unit, and a presentation informing unit. The presenting unit presents to a user the ad information of the electronic advertisement received by the electronic advertisement receiving unit. The presentation informing unit informs an advertiser of presentation information representing that the ad information of the electronic advertisement has been presented by the presenting unit.

The electronic advertisement receiving apparatus can thus prove that the ad information supplied from the advertiser is confirmed by the user using the presentation information. The advertiser can then know by being informed of the presentation information that the ad information is presented to the user and the user confirms the contents.

In this way, the advertiser can confirm in situ whether or not the ad information supplied to the user as the electronic advertisement has been confirmed by the user, in other words, the advertiser can know the advertising effects achieved by distributing the ad information as the electronic advertisement.

The ad information is presented via a display device or speech output device.

The electronic advertisement receiving unit may include an electronic advertisement accepting unit for accepting an electronic advertisement distributed through communication and may include an electronic advertisement reading unit for reading an electronic advertisement from a recording medium on which the electronic advertisement is stored in advance.

Regarding the electronic advertisement receiving apparatus, the electronic advertisement includes identifying information for uniquely identifying that electronic advertisement. The electronic advertisement receiving apparatus may further include an electronic advertisement storing unit and an electronic advertisement storage control unit. The electronic advertisement storing unit stores at least one electronic advertisement received by the electronic advertisement receiving unit. The electronic advertisement storage control unit stores the electronic advertisement received by the electronic advertisement receiving unit, when the identifying information does not match the identifying information of each of the at least one electronic advertisement stored in the electronic advertisement storing unit, in the electronic advertisement storing unit.

Therefore, the electronic advertisement storage control unit allows the electronic advertisement storing unit to store only those electronic advertisements different from each other in the identifying information. The electronic advertisement storing unit thus never stores the same electronic advertisements, which saves memory consumption of the electronic advertisement storing unit and consequently the electronic advertisement receiving apparatus.

The electronic advertisement receiving apparatus further includes a presentation information output unit for outputting the presentation information to the user. The presentation information includes benefit information representing benefits offered from the advertiser to the user in return for presentation of a corresponding advertisement information of the electronic advertisement.

The user can thus gain the benefits from the advertiser in return for confirmation of the presented ad information of the supplied electronic advertisement. The gained benefits are presented similarly to the ad information so that the user can easily ascertain the benefits.

Regarding the electronic advertisement receiving apparatus, the benefits are updated according to the number of times or a time period a corresponding ad information of the electronic advertisement is presented.

The benefits are more frequently updated if the user confirms a greater number of times the presented ad information of the electronic advertisement or the user confirms the ad information for a longer period.

Therefore, the user would try to present the ad information more frequently or for a longer period for the purpose of gaining greater benefits. Consequently, the advertiser can achieve higher advertising effects by using the electronic advertisement.

Regarding the electronic advertisement receiving apparatus, the electronic advertisement includes procedure information representing a procedure for generating the presentation information while updating the benefits. The electronic advertisement receiving apparatus further includes a presentation information generating unit. The presentation information generating unit generates the presentation information while updating the benefits according to the procedure information for the electronic advertisement received by the electronic advertisement receiving unit.

In this way, the presentation information generating unit generates the presentation information while updating the benefits according to the procedure information in the received electronic advertisement. It is unnecessary for the electronic advertisement receiving apparatus to prepare procedure information concerning update of the benefits for the electronic advertisement and generation or update of the presentation information because this information is supplied together with the electronic advertisement.

The advertiser can then determine the procedure for updating the benefits and generating the presentation information as desired for each electronic advertisement. Preparation of the procedure information is unnecessary at the electronic advertisement receiving apparatus of the user and thus the load and cost of the electronic advertisement receiving apparatus can be reduced.

The procedure information concerning update of the benefits for the electronic advertisement and generation or update of the presentation information is program data executed by using the presentation information generating unit.

An electronic advertisement confirming apparatus according to another aspect of the invention for achieving the objects described above includes an electronic advertisement supply unit for supplying to a user an electronic advertisement including advertisement information converted into electronic information, a presentation information receiving unit, and a presentation information output unit. The presentation information receiving unit receives from the user supplied with the electronic advertisement presentation information representing that the advertisement information of the electronic advertisement has been presented to the user. The presentation information output unit outputs the presentation information received by the presentation information receiving unit.

An advertiser can accordingly make sure, when the advertiser supplies ad information as the electronic advertisement to the user, that the ad information is presented to the user and the user confirms its contents, by receiving the presentation information.

The advertiser can thus confirm without inquiry whether or not the ad information supplied to the user as the electronic advertisement is confirmed by the user, namely the advertiser can ascertain the advertising effects achieved by distributing the ad information as the electronic advertisement.

The ad information is presented via a display device or speech output device.

The electronic advertisement confirming apparatus further includes a validity confirming unit for confirming validity of the presentation information received by the presentation information receiving unit. The presentation information includes benefit information representing benefits supplied from the advertiser to the user in return for presentation of corresponding ad information of the electronic advertisement.

The advertiser can thus confirm the validity of the presentation information provided from the user by means of the validity confirming unit. If the presentation information is falsified by the user, the advertiser can know in advance the invalidity of the presentation information and accordingly it is possible to avoid falsified benefits from being used. The user can gain benefits from the advertiser in return for confirmation of presented ad information of the supplied electronic advertisement and can also confirm the acquired benefits together with the ad information.

The electronic advertisement confirming apparatus may further include a presentation information storing unit for storing for each user the presentation information with its validity confirmed by the validity confirming unit, and an analyzed electronic advertisement supply unit. The analyzed electronic advertisement supply unit analyzes for each user the ad information corresponding to the presentation information stored in the presentation information storing unit to supply to the user via the electronic advertisement supply unit the electronic advertisement corresponding to the ad information having contents reflecting the analysis.

The advertiser analyzes for each user the ad information presented to that user and can accordingly supply the electronic advertisement having the ad information with its contents reflecting the analysis. In this way, the advertiser can specify the ad information with contents which the user would have interest in, based on the analysis, and then supply that information to the user. Consequently, high advertising effects can be achieved using the electronic advertisement.

Regarding the electronic advertisement confirming apparatus, a plurality of electronic advertisements corresponding to ad information having the same contents are supplied to different users, and include respective pieces of identifying information for uniquely identifying the electronic advertisements. The pieces of identifying information corresponding to respective pieces of presentation information stored in the presentation information storing unit are different from each other.

It never occurs that electronic advertisements corresponding to ad information having the same contents are supplied to the same user. Those electronic advertisements can be supplied to respective users one by one. This is especially advantageous when the number of electronic advertisements to be supplied is limited. The electronic advertisement presentation information storing unit never stores pieces of presentation information corresponding to the same identifying information so that the memory capacity can effectively be utilized and the analysis mentioned above can be made with high precision.

An electronic advertisement supply system according to still another aspect of the invention for achieving the above objects includes an electronic advertisement distribution apparatus distributing an electronic advertisement including ad information corresponding to an advertiser, the ad information being converted into electronic information, and includes an electronic advertisement receiving apparatus receiving the electronic advertisement and presenting the electronic advertisement to a user.

The electronic advertisement distribution apparatus includes an electronic advertisement transmitting unit for transmitting the electronic advertisement corresponding to the ad information requested by the advertiser to be distributed, the electronic advertisement being transmitted together with an identifier for uniquely identifying the electronic advertisement. The electronic advertisement receiving apparatus includes a response data transmitting unit for generating, when the electronic advertisement is transmitted from the electronic advertisement transmitting unit and received, response data representing reception of the electronic advertisement based on the identifier received together with the received electronic advertisement and transmitting the generated response data to the electronic advertisement distribution apparatus.

The electronic advertisement distribution apparatus can make sure, when it distributes the electronic advertisement together with the identifier, that the electronic advertisement is received by the electronic advertisement receiving unit and presented to the user, by receiving the response data based on the identifier.

Regarding the electronic advertisement supply system, the electronic advertisement distribution apparatus further includes a response data receiving unit for receiving the response data transmitted from the response data transmitting unit, and a distribution ending unit. The distribution ending unit calculates the number of distributed electronic advertisements based on the response data received by the response data receiving unit for ending distribution of the electronic advertisements when the calculated number reaches a predetermined number.

When the predetermined number of electronic advertisements are distributed, distribution of the electronic advertisements is completed when the predetermined number of response data are received.

Regarding the electronic advertisement supply system, the electronic advertisement distribution apparatus distributes the electronic advertisement to a restricted area.

The electronic advertisement can thus be supplied to a limited area which the advertiser desires, so that the advertiser can make advertisement in the restricted area.

The electronic advertisement supply system further includes an electronic advertisement confirming apparatus for the advertiser. The electronic advertisement confirming apparatus includes an electronic advertisement distribution request unit for requesting the electronic advertisement distribution apparatus to distribute the electronic advertisement, a presentation information receiving unit, and a presentation information output unit. The presentation information receiving unit receives presentation information representing presentation of the electronic advertisement to the user receiving the distributed electronic advertisement. The presentation information output unit outputs the presentation information received by the presentation information receiving unit.

The advertiser thus receives the presentation information, when the advertiser distributes the electronic advertisement to the user and the electronic advertisement is received by and presented to the user. Accordingly the advertiser can ascertain without asking the user whether or not the user has confirmed the ad information supplied as the electronic advertisement, namely the advertiser can make sure the advertising effects of distributing the ad information as the electronic advertisement.

Regarding the electronic advertisement supply system, the electronic advertisement confirming apparatus further includes a presentation information storing unit for storing for each user the presentation information received by the presentation information receiving unit. The ad information corresponding to the presentation information stored in the presentation information storing unit is analyzed for each user and the electronic advertisement corresponding to the ad information having contents reflecting the analysis is distributed to the user via the electronic advertisement distribution request unit.

The advertiser can thus analyze for each user the ad information presented to the user and accordingly supply the electronic advertisement of the ad information having its contents reflecting the analysis. Then, the advertiser can supply the electronic advertisement of the ad information which the user would have interest in, based on the analysis, and accordingly achieve high advertising effects utilizing the electronic advertisement.

Regarding the electronic advertisement supply system, the presentation information includes benefit information representing benefits offered from the advertiser to the user in return for presentation of corresponding ad information of the electronic advertisement.

The user can gain the benefits from the advertiser in return for confirmation of the presented ad information of the received electronic advertisement and the advertiser can ascertain without making inquiry that the user gains the benefits.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 generally shows a structure of an electronic advertisement distribution system applied to embodiments of the present invention.

FIG. 2 is a hardware block diagram showing an electronic advertisement distribution apparatus 101 and relevant components according to a first embodiment.

FIG. 3 is a functional block diagram showing an electronic advertisement receiving apparatus 102 according to the first embodiment.

FIGS. 4A and 4B show a functional block diagram of an electronic advertisement confirming apparatus 103 according to the first embodiment.

FIG. 5 is a flowchart illustrating a method of reproducing an electronic advertisement by electronic advertisement receiving apparatus 102 according to the first embodiment.

FIG. 6 shows a data structure of an electronic advertisement supplied from electronic advertisement distribution apparatus 101 to a user according to the first embodiment.

FIGS. 7A to 7F illustrate examples of display by an information output unit 306 according to the first embodiment.

FIG. 8 is a flowchart illustrating a process to enable a user to gain benefits from an advertiser.

FIG. 9 shows a data structure of an electronic advertisement according to a second embodiment.

FIG. 10 is a flowchart illustrating a process concerning electronic advertisement distribution according to the second embodiment.

FIG. 11 is a flowchart illustrating a process to enable a user to gain benefits from an advertiser according to the second embodiment.

FIG. 12 shows a data structure of an electronic advertisement according to a third embodiment.

FIG. 13 is a flowchart illustrating a process of generating a reproduction stamp according to the third embodiment.

FIGS. 14A to 14G illustrate examples of display by an information output unit 306 according to the third embodiment.

FIG. 15 is a flowchart illustrating a process by an electronic advertisement confirming apparatus 103 according to a fourth embodiment.

FIGS. 16A and 16B illustrate distribution areas of electronic advertisements according to a fifth embodiment.

### DESCRIPTION OF THE PREFERRED EMBODIMENTS

Embodiments of the present invention are now described in conjunction with the drawings. Electronic advertisement information generated by converting ad information through electronic processing is herein referred to as electronic advertisement. Here, reproduction of electronic advertisements means that the electronic advertisements are processed such that users can confirm contents of ad information represented by the electronic advertisements. Specifically, the electronic advertisements are converted for example into images, speech and the like to be output (presented) to users.

### First Embodiment

Description of the first embodiment is given below.

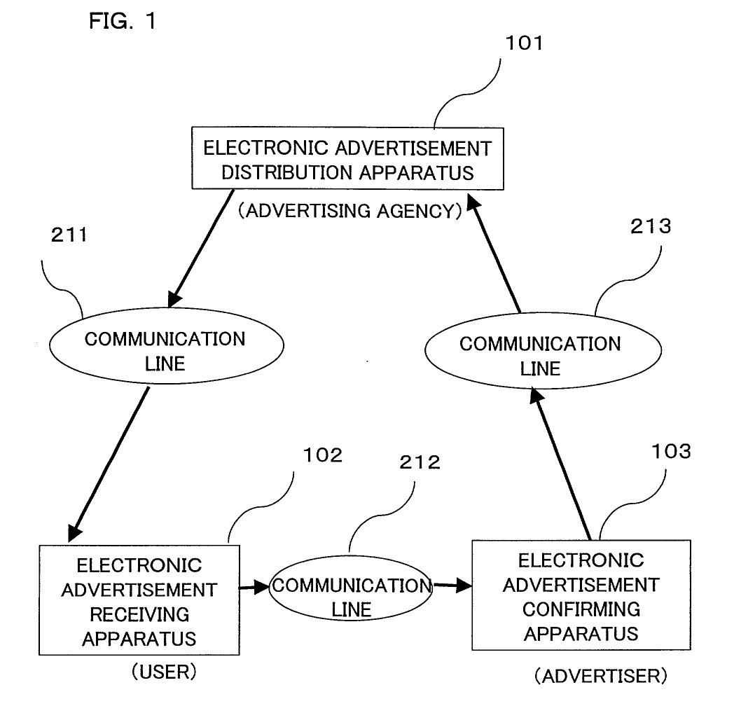

FIG. 1 generally shows a structure of an electronic advertisement distribution system applied to embodiments of the present invention. Referring to FIG. 1, the electronic advertisement distribution system includes an electronic advertisement distribution apparatus 101 provided correspondingly to an advertising agency of an electronic advertisement, an electronic advertisement receiving apparatus 102 provided correspondingly to a user receiving the electronic advertisement distributed thereto, an electronic advertisement confirming apparatus 103 provided correspondingly to an advertiser of the electronic advertisement, and communication lines 211 to 213 corresponding to various communication channels including the Internet. Electronic advertisement distribution apparatus 101 and electronic advertisement receiving apparatus 102 communicate with each other via communication line 211, electronic advertisement receiving apparatus 102 and electronic advertisement confirming apparatus 103 communicate with each other via communication line 212, and electronic advertisement distribution apparatus 101 and electronic advertisement confirming apparatus 103 communicate with each other via communication line 213. Although this electronic advertisement distribution system is shown to include one electronic advertisement distribution apparatus 101, one electronic advertisement receiving apparatus 102 and one electronic advertisement confirming apparatus 103 for simplifying description, the number thereof may be more than one for each apparatus. In addition, although these apparatuses are connected by individual communication lines, they may be connected by the same communication line.

A flow of a process in using the electronic advertisement distribution system is discussed below in conjunction with FIG. 1.

First, the advertiser intending to supply advertisement information asks the ad agency serving to distribute the ad information to distribute the ad information by payment of a distribution fee. The ad information here may be contents shown on a sheet of paper as conventionally done or electronic data prepared in advance. The ad agency then converts the ad information for which distribution is requested into an electronic advertisement and registers the converted information in a memory of electronic advertisement distribution apparatus 101. At this time, if the ad information is shown on a sheet of paper, the information may be converted into the electronic one by means of a scanner or the like. If electronic data is prepared in advance, the data may be transmitted from the advertiser through the Internet or the like to electronic advertisement distribution apparatus 101 for registration.

Further, the electronic advertisement is produced together with identifying information indicating reproduction of the electronic advertisement by the user (the id information is hereinafter referred to reproduction stamp). If requested by the advertiser, the ad agency informs the advertiser of the reproduction stamp by means of the Internet or the like. The ad agency thereafter distributes the registered electronic advertisement to the user.

In the electronic advertisement distribution system according to the invention, the distribution method is not specific one and any distribution method appropriate for the ad agency and user may be selected. Various methods are possible for distribution such as the one by means of wireless media for existing mobile phone (hereinafter cellular phone) and the like, by means of wired media like existing telephone lines, by means of recording media like FD (flexible disk), or by means of apparatuses (not shown), located at station kiosks and on the street, which can provide the electronic advertisement to the user and from which the user freely downloads the advertisement. If the wireless media or wired media are employed, electronic advertisement distribution apparatus 101 and electronic advertisement receiving apparatus 102 are connected online using communication line 211, and any desired electronic advertisement is downloaded from electronic advertisement distribution apparatus 101 to electronic advertisement receiving apparatus 102 via communication line 211. If the recording medium is employed, the ad agency distributes the recording medium on which electronic advertisements are recorded in advance and the user can read and confirm a desired electronic advertisement recorded on the recording medium by electronic advertisement receiving apparatus 102. It is noted that the electronic advertisement may be data with time limit. The time limit of the electronic advertisement corresponds to an expiry date or valid duration period of time).

Next, the user reproduces the electronic advertisement downloaded into electronic advertisement receiving apparatus 102 and confirms contents of the ad information. At this time, electronic advertisement receiving apparatus 102 generates a reproduction stamp for the reproduced electronic advertisement. Methods of reproducing an electronic advertisement and of generating a reproduction stamp are discussed later. If the reproduced ad information indicates that any product which the user hopes to purchase will be provided with desired benefits, the user informs the advertiser of the reproduction stamp by using the existing Internet or the like and then can purchase from the advertiser the product with the desired benefits. The benefits mentioned above may be those meeting needs of both of the user and advertiser. For example, the benefits are services of offering discount of merchandise, discount coupons which can be used in purchase of goods, free gifts or the like.

The advertiser then checks the reproduction stamp presented by the user against the reproduction stamp informed in advance by the ad agency by using electronic advertisement confirming apparatus 103. According to the result of checking, the advertiser judges the validity of the reproduction stamp presented by the user. If valid, the advertiser provides benefits attached to the corresponding electronic advertisement to the user. At this time, if the electronic advertisement is data with time limit, the expiry date of the corresponding ad information is checked.

In the electronic advertisement distribution system, the advertising effects for the advertiser can be enhanced by distributing electronic advertisements to an increased number of users. Consequently, electronic advertisement distribution apparatus 101 has its structure increased in size for distributing electronic advertisements. For this reason, the ad agency serving to distributing electronic advertisements generally owns electronic advertisement distribution apparatus 101. However, if the existing media like the Internet are used, this means that the advertiser owns electronic advertisement distribution apparatus 101. The ad agency is thus unnecessary and information regarding electronic advertisements is supplied/received between the advertiser and user.

The user informs the advertiser of the reproduction stamp in the following way. When electronic advertisement receiving apparatus 102 is not a stationary apparatus like personal computer but a portable mobile device such as mobile information processing terminal device and cellular phone that allows the user to bring electronic advertisement receiving apparatus 102 to a shop of the advertiser, the user presents the reproduction stamp in front of the advertiser by electronic advertisement receiving apparatus 102 to inform the advertiser of the reproduction stamp. Then, the advertiser can confirm the presented reproduction stamp visually. Electronic advertisement confirming apparatus 103 is thus unnecessary.

Alternatively, the user can electronically inform the advertiser of the reproduction stamp through a short-haul communication system using infrared radiation such as IrDA (Infrared Data Association) and Bluetooth. In this case, any damage due to falsification of data can be prevented by providing an electronic watermark in the reproduction stamp. Further, the advertiser can electronically store the informed reproduction stamp as a record of utilization of the advertisement by the user. If benefits of an electronic advertisement having time limit are not used, the electronic advertisement may be displayed on electronic advertisement receiving apparatus 102 before the expiry date to present the advertisement to the user so as to induce the user to enjoy benefits of the electronic advertisement.

In addition to text data, image data and the like provided by a display system, data provided by a speech system may be applied to electronic advertisements.

Electronic advertisements are reproduced by electronic advertisement receiving apparatus 102 by display means or the like if the electronic advertisements are of the display system, and speaker means or the like are used for data of the speech system.

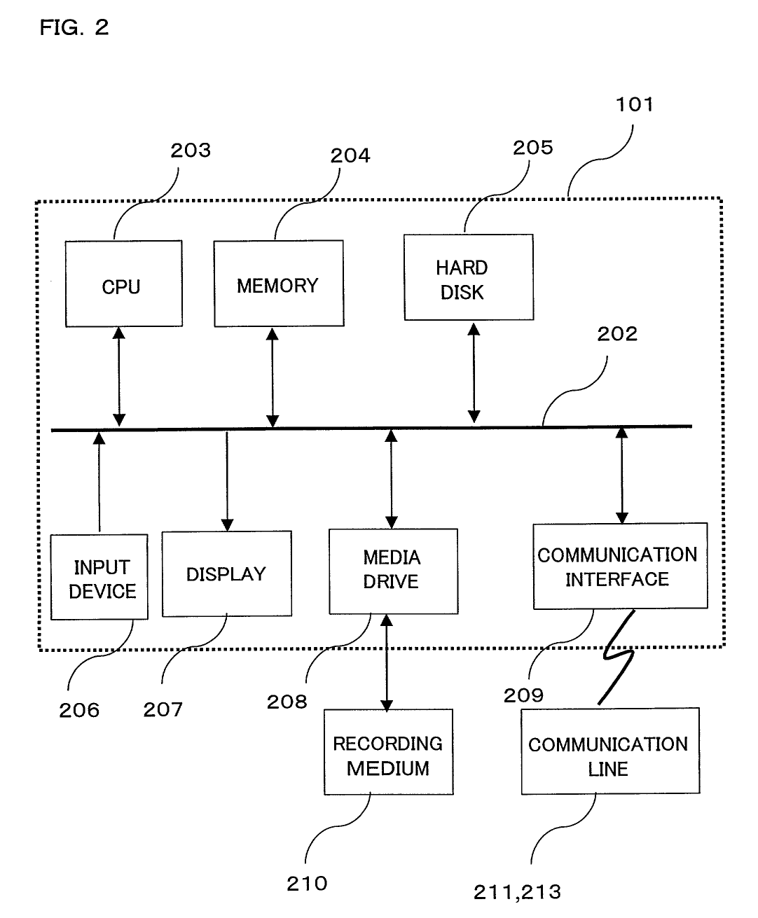

FIG. 2 is a hardware block diagram showing electronic advertisement distribution apparatus 101 and relevant components according to the first embodiment. Electronic advertisement distribution apparatus 101 includes in the enclosure by the dotted line in FIG. 2 a bus line 202, and a CPU (Central Processing Unit) 203, a memory 204, a hard disk 205, an input device 206, a display 207, a media drive 208 and a communication interface 209 that are connected via bus line 202.

CPU 203 is structured including a microprocessor to execute a program preliminary stored in memory 204 or hard disk 205 and accordingly control the entire apparatus. Memory 204 is structured including a RAM (Random Access Memory) and a ROM (Read Only Memory) to store various programs and data. Data regarding electronic advertisements to be distributed is stored in hard disk 205.

Input device 206 is an interface for converting ad information for which the advertiser requests distribution into electronic information and includes a scanner, microphone and the like. Display 207 is used for displaying management information concerning electronic advertisements and used for confirming an image of an electronic advertisement.

Media drive 208 with a recording medium 210 like FD detachably attached thereto writes electronic advertisements into the attached recording medium and reads electronic advertisements from the attached recording medium.

Communication interface 209 serves as an interface between electronic advertisement distribution apparatus 101 and communication line 211 or 213 for cellular phone, PHS (trade name: Personal Handy Phone System), telephone line, Ethernet (trade name) and the like and is used for distributing electronic advertisements from the ad agency to users or registering electronic advertisements by the advertiser in electronic advertisement distribution apparatus 101 via communication line 213.

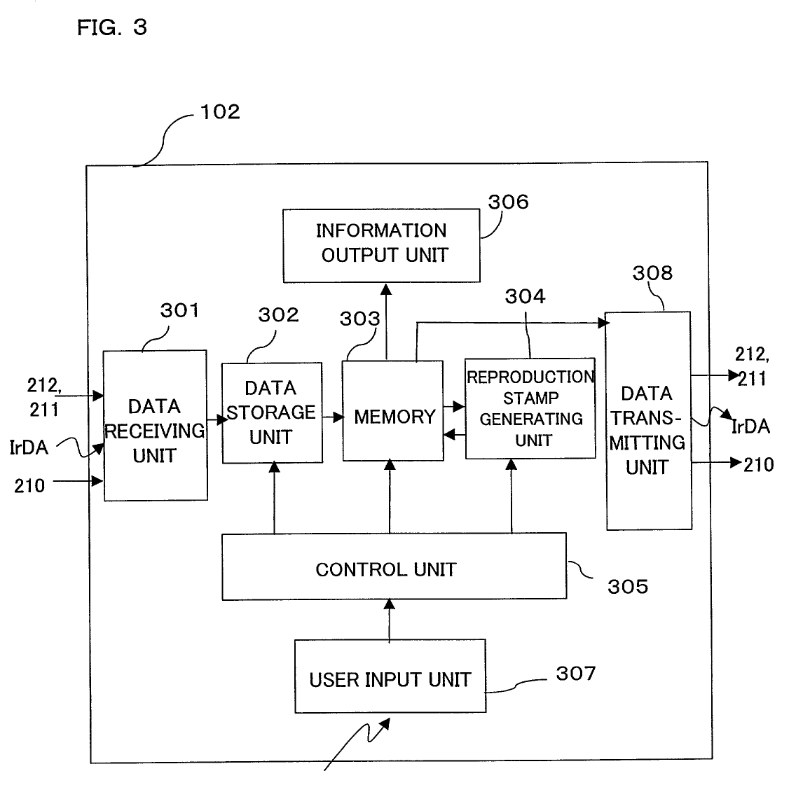

FIG. 3 is a functional block diagram showing electronic advertisement receiving apparatus 102 according to the first embodiment. Referring to FIG. 3, electronic advertisement receiving apparatus 102 includes a data receiving unit 301, a data storage unit 302, a memory 303, a reproduction stamp generating unit 304, a control unit 305, an information output unit 306, a user input unit 307 and a data transmitting unit 308.

Data receiving unit 301 is constituted of a communication interface for wired communication using telephone lines and the like, an interface for wireless communication like IrDA communication, and an interface for recording media like recording medium 210. Data receiving unit 301 receives information transmitted via communication line 211 or 212 as well as electronic advertisements supplied from recording medium 210.

Data storage unit 302 includes an internal memory (not shown) to store and accumulate in the internal memory electronic advertisements received by data receiving unit 301.

In memory 303, data for displaying icons corresponding to the accumulated electronic advertisements, data for displaying reproduction stamps and other data are stored.

Reproduction stamp generating unit 304 generates or updates display data for reproduction stamps and stores the generated or updated display data for reproduction stamps in memory 303.

Control unit 305 controls data storage unit 302, memory 303 and reproduction stamp generating unit 304 individually and also controls the entire apparatus.

Information output unit 306 includes a display device like display and a speech output device like speaker to indicate on the display device icons of electronic advertisements, reproduction stamps and various information and provide speech output of ad information by the speech output device based on contents stored in memory 303.

User input unit 307 includes a touch panel, a keyboard and the like to serve as a manipulation interface between a user and this apparatus and is manipulated for selecting an icon of an electronic advertisement displayed on information output unit 306.

Data transmitting unit 308 includes, similarly to data receiving unit 301, a communication interface for wired communication line 211 or 212 using telephone lines and the like, an interface for wireless communication using IrDA and the like and an interface for recording media including recording medium 210 to be used for presenting reproduction stamps to the advertiser.

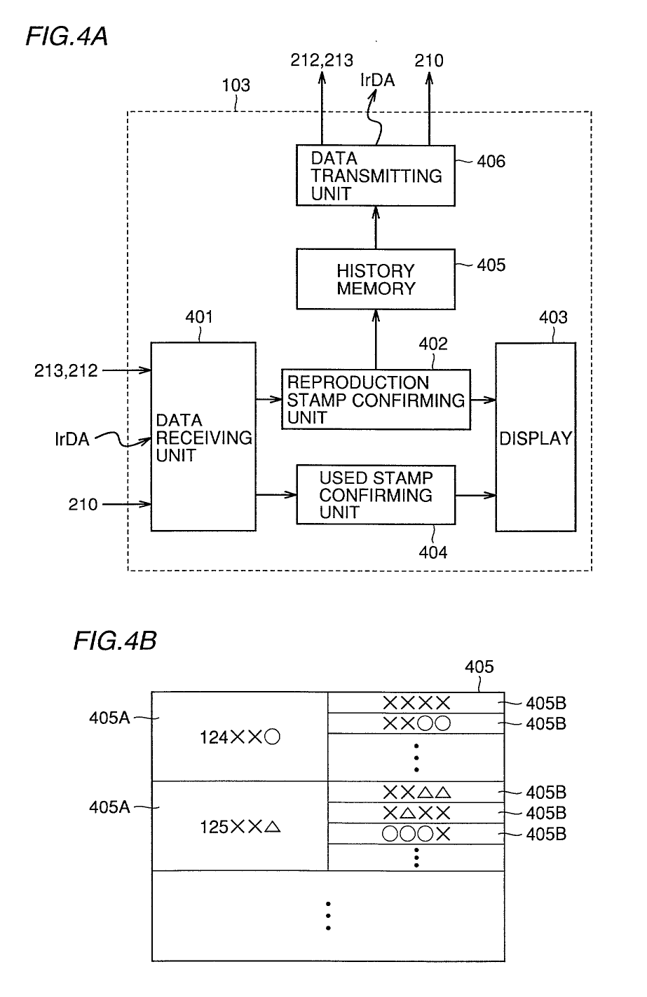

FIGS. 4A and 4B show a functional block diagram of electronic advertisement confirming apparatus 103 according to the first embodiment. Referring to FIG. 4A, the electronic advertisement confirming apparatus includes a data receiving unit 401, a reproduction stamp confirming unit 402, a display 403, a used stamp confirming unit 404, a history memory 405 and a data transmitting unit 406.

Data receiving unit 401 includes a communication interface for wired communication line 213 or 212 using telephone lines and the like, an interface for wireless communication using IrDA and the like and an interface for recording media including recording medium 210, and is used for receiving the reproduction stamp supplied from the user.

Reproduction stamp confirming unit 402 checks the reproduction stamp from the user received by data receiving unit 401 against the reproduction stamp from the ad agency when the request for electronic advertisement distribution is made in order to confirm the validity of the reproduction stamp from the user.

Display 403 presents results of confirmation by reproduction stamp confirming unit 402 and used stamp confirming unit 404.

Referring to FIG. 4B, history memory 405 stores, for each user, user identifying information (e.g. name of the user) 405A for identifying the user and at least one kind of reproduced data that is reproduced electronic advertisement data, user identifying information 405A and reproduced data 405B being correlated with each other.

Data transmitting unit 406 includes a communication interface for wired communication line 212 or 213 using telephone lines and the like, an interface for wireless communication like IrDA and an interface for recording media including recording medium 210, and is used for directly distributing an electronic advertisement regarding the user or for requesting distribution of the electronic advertisement to the ad agency.

Used stamp confirming unit 404 is not used in the first embodiment and description thereof is not given here.

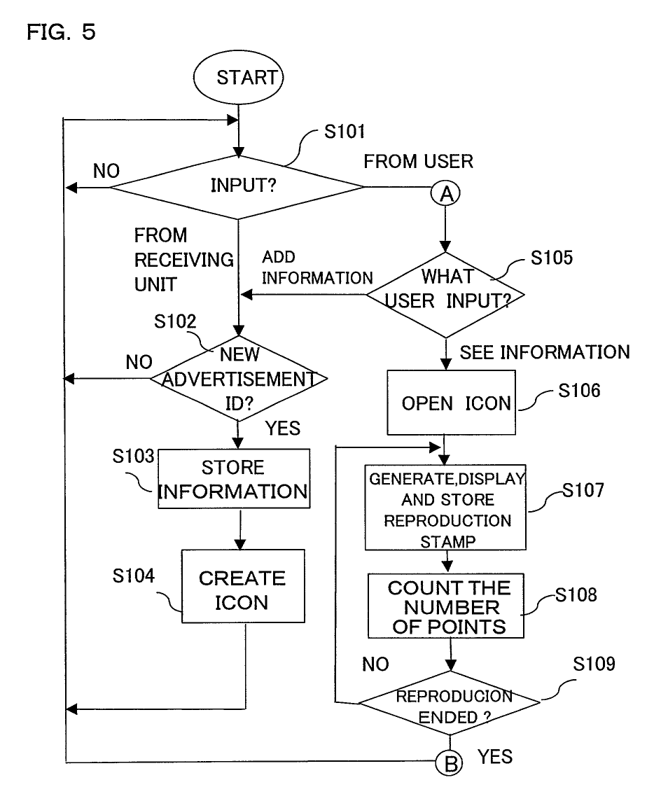

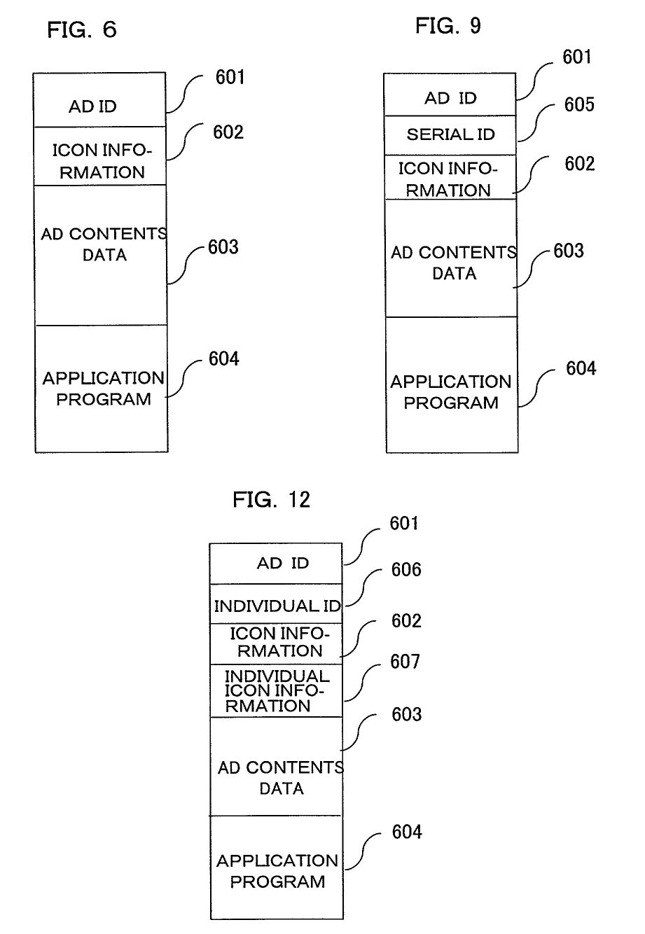

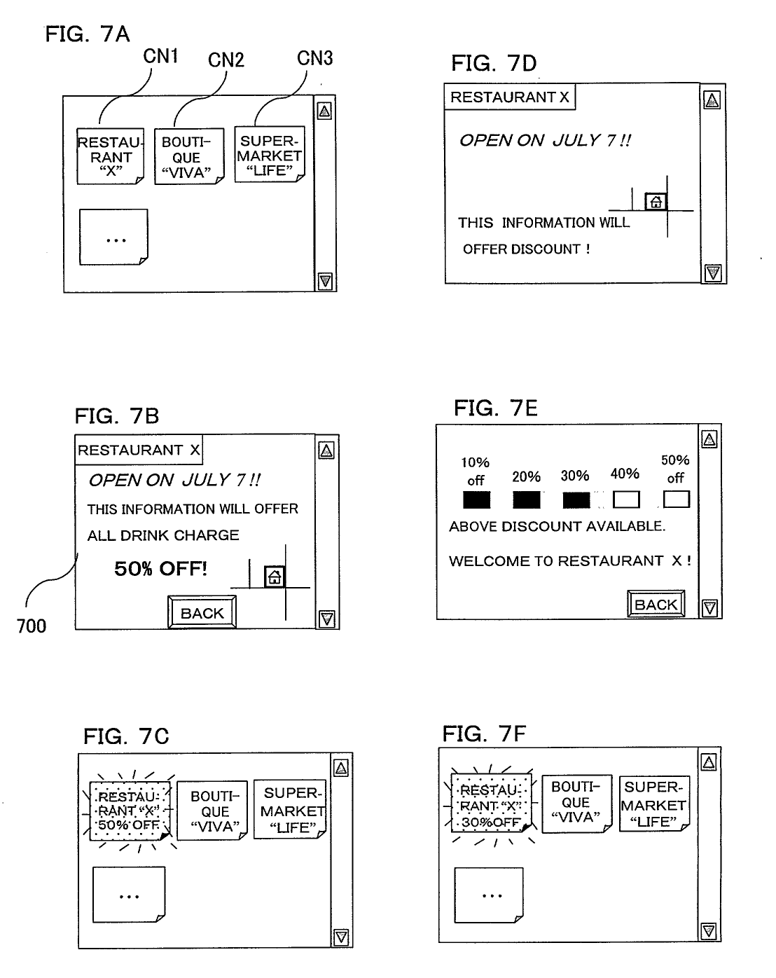

FIG. 5 is a flowchart illustrating a method of reproducing an electronic advertisement by electronic advertisement receiving apparatus 102 according to the first embodiment. The process following the flowchart in FIG. 5 is executed under control by control unit 305 of electronic advertisement receiving apparatus 102. FIG. 6 shows a data structure of an electronic advertisement distributed to users from electronic advertisement distribution apparatus 101 according to the first embodiment. FIGS. 7A to 7F illustrate display examples by information output unit 306 according to the first embodiment.

Referring to FIG. 6, an electronic advertisement includes an advertisement ID (Identification) 601 for uniquely identifying the electronic advertisement, an icon information 602 for displaying an icon corresponding to this electronic advertisement on information output unit 306, ad contents data 603 and an application program 604. Ad contents data 603 indicates contents of ad information that is output when the user selects a corresponding icon. Application program 604 is used for executing processes of displaying the icon of the electronic advertisement, displaying contents of ad information when a corresponding icon is selected, and generating and displaying a reproduction stamp. The electronic advertisement may further include information for specifying where the user can contact the advertiser, for example, information about an Internet address or phone number. If the electronic advertisement is data with time limit, data on the date and time period indicating the expiry date is included.

The arrangement of data in the data structure of the electronic advertisement and the specific data mapping method are not limited. It is just required that the process for generating a reproduction stamp and like processes can be performed.

Following the flowchart in FIG. 5, methods of reproducing an electronic advertisement distributed from electronic advertisement distribution apparatus 101 and generating a reproduction stamp indicating that the electronic advertisement has been reproduced by electronic advertisement receiving apparatus 102 are described below.

In step S101, it is checked whether there occurs external input. The external input means that an electronic advertisement is received by data receiving unit 301 or data is input through manipulation of user input unit 307 by a user.

When reception of an electronic advertisement is detected in step S101, it is checked in step S102 whether data storage unit 302 has already stored an electronic advertisement having the same ad ID 601 as ad ID 601 of the received electronic advertisement. If there has already been such electronic advertisement stored therein, the received electronic advertisement is not stored in data storage unit 302 and step S101 is performed again.

If there is no such electronic advertisement stored, the received electronic advertisement is stored in data storage unit 302 in step S103. In step S104, corresponding application program 604 and icon information 602 are used to generate corresponding icon data to be stored in memory 303, and thereafter an icon according to this data is displayed on information output unit 306. The process of receiving the electronic advertisement is now completed and step S101 is performed again to enter an external input waiting state.

FIG. 7A shows an example of display on information output unit 306 when a plurality of electronic advertisements are received through the process described above. In FIG. 7A, icons CN1 to CN3 are displayed corresponding respectively to the received electronic advertisements. When a user selects icon CN1 of RESTAURANT “X” for example via user input unit 307, ad information concerning the restaurant “X” is displayed according to ad contents data 603 of the electronic advertisement corresponding to that icon, and then the user can confirm this.

If electronic advertisement receiving apparatus 102 receives an electronic advertisement via communication line 211 or the like, the receiving operation can be performed as desired by the user using a receiving mode changing switch (not shown) of user input unit 307. Specifically, when manipulation of user input unit 307 by the user is detected in step S101, what type of manipulation is made is checked in step S105. If the manipulation is done for adding information namely requesting reception of an electronic advertisement, step S102 is performed. Subsequent process steps are followed as described above and not described here.

Reproduction of an electronic advertisement by electronic advertisement receiving apparatus 102 is now described. The user selects a desired icon displayed on information output unit 306 via user input unit 307 (steps S101, S105 and S106). The desired icon is selected to start corresponding application program 604 so that ad contents data 603 corresponding to the selected icon is displayed on information output unit 306. At this time, a reproduction stamp is generated by reproduction stamp generating unit 304 to be stored in memory 303 (step S107). According to the first embodiment, the reproduction stamp is generated by updating display data for the desired icon selected as discussed above using data indicating benefits described later. Therefore, the reproduction stamp is generated by application program 604 based on icon information 602.

FIG. 7B shows an example of display of ad information based on ad contents data 603 when icon CN1 of RESTAURANT “X” is selected. In this case, it can be seen that the user receives from the advertiser a benefit 700 “ALL DRINK CHARGE 50% OFF.” If this electronic advertisement is data with time limit, the expiry date is indicated together with benefit 700 “ALL DRINK CHARGE 50% OFF.”

The ad information corresponding to the desired icon is thus displayed and then control unit 305 counts points concerning the reproduction time or the number of times the reproduction is done for that electronic advertisement in step S108. Based on the count value, the reproduction stamp is updated. Contents of application program 604 determine whether the points are counted following the reproduction time or the number of reproduction times or no counting is performed. Regarding the reproduction stamps displayed on FIGS. 7D and 7E, for example, the points are counted up according to the number of reproduction times and consequently the discount rate is raised. FIG. 7E shows that the discount rate is 30% because the number of reproduction times is three.

If the points are counted according to the reproduction time, there is the possibility that the ad information of an electronic advertisement having been reproduced and displayed is left without being watched by the user. In order to prevent this, it is desirable to request the user to input something via user input unit 307 at certain time intervals.

After the electronic advertisement is reproduced and the points are counted, steps S107 to S109 are repeated until the user manipulates user input unit 307 for ending the reproduction (Yes in step S109). When the reproduction ending manipulation is performed (Yes in step S109), the generated reproduction stamp is replaced with a corresponding electronic advertisement icon to be displayed and then step S101 is performed again. FIGS. 7C and 7F show that generated reproduction stamps are replaced with corresponding electronic advertisement icons to be displayed. Specifically, icons in FIGS. 7C and 7F corresponding to RESTAURANT “X” are displayed respectively having characters “50% OFF” and “30% OFF” together with RESTAURANT “X”. Reproduction stamps are easier to see for users if displayed with color changing or flushing. Here, the reproduction stamp is displayed based on icon display data. However, any simpler display method may be employed and it is just necessary that the stamp is displayed in a form different from that before reproduction of the electronic advertisement.

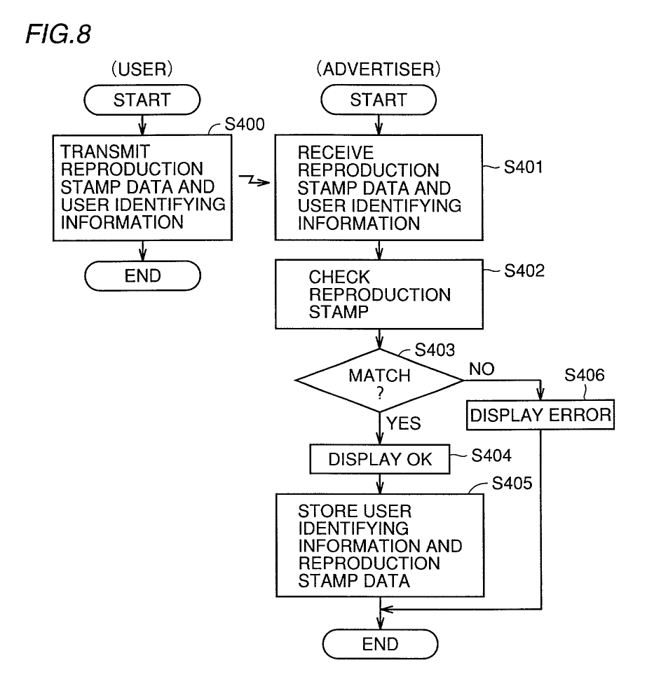

FIG. 8 is a flowchart showing a process through which the user obtains benefits from the advertiser.

The user receives and reproduces an electronic advertisement as described above and can accordingly enjoy benefits from the advertiser that are provided based on results of the reproduction.

In step S400, the user transmits to the advertiser via data transmitting unit 308 of electronic advertisement receiving apparatus 102, information for specifying a reproduction stamp and the identification of the user (e.g. name of the user) through communication line 212 such as the Internet. In step S401, the transmitted data is received by data receiving unit 401 of electronic advertisement confirming apparatus 103 of the advertiser.

In step S402, in reproduction stamp confirming unit 402, in order to ascertain the validity of the transmitted reproduction stamp data, the transmitted reproduction stamp is checked against reproduction stamps of multiple types informed in advance from the ad agency. As discussed above, the reproduction stamp from the user is the one generated by updating corresponding electronic advertisement icon data according to points. Therefore, those reproduction stamps of multiple types informed in advance from the ad agency to the advertiser correspond to data of icons of multiple types updated according to points. After the checking result shows matching and the validity of the supplied reproduction stamp is confirmed in step S403, OK is indicated on display 403 in step S404. In step S405, the contents received in step S401 are correlated with user identifying information 405A and reproduced data 405B and stored in history memory 405. If unmatching is found by the checking and the validity of the supplied reproduction stamp cannot be confirmed in step S403, error display is indicated on display 403 in step S406.

After this, when the user visits a shop of the advertiser and the validity of the reproduction stamp corresponding to the user has been confirmed in advance, the advertiser offers to the user benefits corresponding to the reproduction stamp supplied from the user. At this time, if the electronic advertisement corresponding to the reproduction stamp supplied from the user is data with time limit, the expiry date of the ad information is checked. In this example, the benefits of half-price drinks at the restaurant X of the advertiser are supplied to the user.

If the electronic advertisement receiving apparatus 102 is a mobile device, the user brings electronic advertisement receiving apparatus 102 to the restaurant X following the map indicating the route to the restaurant X shown in FIG. 7B to present the reproduction stamp shown in FIG. 7C to the advertiser. The advertiser then ascertains the validity of the presented reproduction stamp through visual confirmation. The validity is judged based on whether the ad information for which the advertiser asks the ad agency to distribute the electronic advertisement as well as corresponding benefits agree with displayed contents of the presented reproduction stamp.

It is noted that communication line 212 is not limited to wired communication lines. In other words, the user may transmit the reproduction stamp and the like to the advertiser through short-haul wireless communication such as IrDA and Bluetooth.

If an electronic advertisement is data with time limit and benefits corresponding to this electronic advertisement are not enjoyed, the user may be informed of this, through information output unit 306 of electronic advertisement receiving apparatus 102 of the user, before the expiry date, and thus induced to receive the benefits.

Although the process discussed above is followed on the assumption that the user him of herself enjoys the benefits, anyone receiving the benefits from the right user may utilize the benefits.

According to the first embodiment, the advertiser can confirm, by receiving the reproduction stamp from the user, that the distributed electronic advertisement is reproduced by the user. Benefits are offered to the user in return for reproduction of the distributed electronic advertisement and confirmation of the ad information by the user.

### Second Embodiment

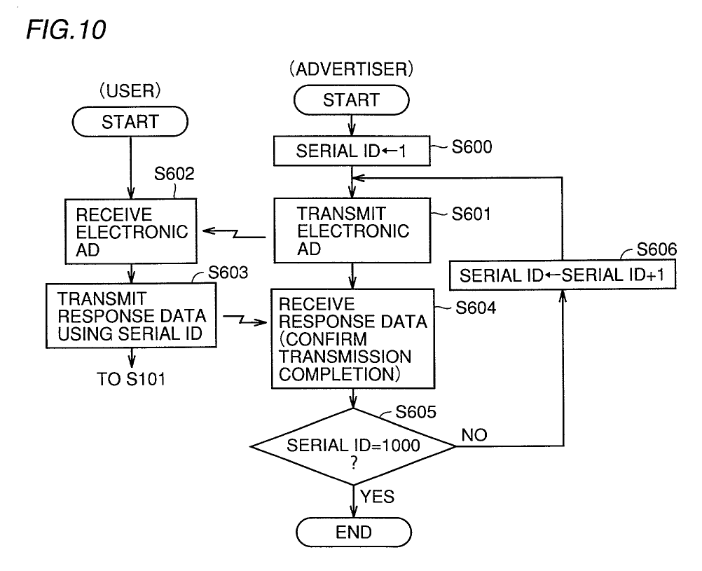

The second embodiment is now described. FIG. 9 shows a data structure of an electronic advertisement according to the second embodiment. FIG. 10 is a flowchart showing a process regarding distribution of electronic advertisements according to the second embodiment. The second embodiment is different from the first embodiment in that a serial ID 605 is added as shown in FIG. 9 to the data structure of the electronic advertisement in FIG. 6 and that the reproduction stamp is generated by using serial ID 605. Other data constituting the electronic advertisement and the apparatus structure are identical to those in the first embodiment and description thereof is not repeated here. According to the second embodiment, serial ID 605 is an identifier allocated to each of a plurality of electronic advertisements having the same contents and is used for confirming, when the electronic advertisements are distributed, that the distribution is completed.

According to the first embodiment, the ad agency unlimitedly provides to the user electronic advertisements for which distribution is requested from the advertiser. Here, suppose that the advertiser is a shopkeeper. Under this situation, there could be a limited number of goods to be sold that correspond to electronic advertisements, or the advertiser may hope that a plurality of different users come to the shop, rather than that the same user comes repeatedly. The second embodiment addresses such needs. According to the second embodiment, the advertiser applies the number of electronic advertisements to be distributed when the advertiser asks distribution of the electronic advertisements. This is hereinafter described following the flowchart in FIG. 10 assuming that the number of distributed advertisements is 1000.

An ad agency distributes to a user an electronic advertisement, in steps S600 and S601, having serial ID 605 with “1” set by CPU 203 via communication interface 209. The user receives the electronic advertisement in step S602 by electronic advertisement receiving apparatus 102 and then generates response data indicating reception of the electronic advertisement and transmits the data to electronic advertisement distribution apparatus 101 via data transmitting unit 308 in step S603. The response data includes serial ID 605 of the electronic advertisement received by the user. In step S604, electronic advertisement distribution apparatus 101 receives the response data and thus can confirm that the corresponding electronic advertisement has been distributed. In other words, from the fact that serial IDs 605 of the distributed electronic advertisement and the supplied response data are both “1,” it is possible to confirm that the electronic advertisement has correctly been distributed.

After step S605, electronic advertisement distribution apparatus 101 distributes in step S606 an electronic advertisement having serial ID 605 with “2” set therein, and waits for response data including serial ID 605 of “2.” This process is subsequently repeated similarly. When “1000” is reached that is the maximum number of electronic advertisements to be distributed, in other words, when it is confirmed that an electronic advertisement having serial ID 605 with “1000” set therein has correctly been distributed by reception of corresponding response data (Yes in step S605), electronic advertisement distribution apparatus 101 stops requested distribution of electronic advertisements.

In electronic advertisement receiving apparatus 102 of the user having received the electronic advertisement from electronic advertisement distribution apparatus 101, processes similar to those in the first embodiment illustrated in the steps following step S101 explained above are performed, specifically, reproduction and counting up for benefits are performed, and a reproduction stamp according to the benefits is produced. The produced reproduction stamp has data added thereto of serial ID 605 of the corresponding electronic advertisement. Therefore, when the reproduction stamp is displayed, the added serial ID 605 data (number) is also displayed (not shown).

According to the method employed in the second embodiment, in order to make sure that distribution of a specified number of electronic advertisements has correctly been completed, the serial numbers “1”, “2”, “3”, . . . are allocated to serial ID 605 of the electronic advertisements for counting the specified number. However, the method is not limited to this. In other words, it is merely necessary that confirmation is possible of the completion of distribution of the specified number of electronic advertisements between electronic advertisement distribution apparatus 101 and electronic advertisement receiving apparatus 102.

As explained above, electronic advertisement receiving apparatus 102 is controlled by using advertisement ID 601 of electronic advertisements such that it never receives the same electronic advertisement. Therefore, if 1000 electronic advertisements are distributed, the electronic advertisements are not received by the same electronic advertisement receiving apparatus 102 over multiple times but received by 1000 different electronic advertisement receiving apparatuses 102 respectively. Electronic advertisement distribution apparatus 101 can distribute, before receiving response data corresponding to serial ID 605 of a predetermined number from electronic advertisement receiving apparatus 102, an electronic advertisement having serial ID 605 with any number subsequent to the predetermined number.

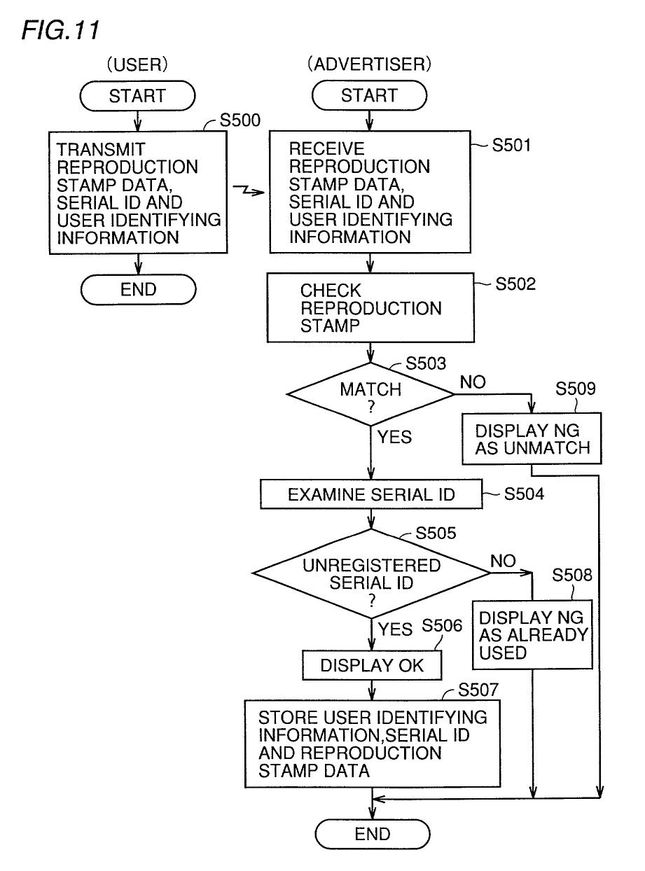

FIG. 11 is a flowchart illustrating a process for the user to receive benefits from the advertiser according to the second embodiment.

The user receives and reproduces the electronic advertisement as discussed above and can thereafter receive from the advertiser benefits based on results of reproduction.

In step S500, the user transmits to the advertiser via communication line 212 such as the Internet data of serial ID 605, a reproduction stamp having data of serial ID 605 added thereto, and information for identifying the user (e.g. name of the user).

In step S501, electronic advertisement confirming apparatus 103 of the advertiser receives these data by data receiving unit 401. In a similar manner to that of the first embodiment, the received reproduction stamp is checked in step S502 by reproduction stamp confirming unit 402. When the validity is confirmed by the check in step S503, used stamp confirming unit 404 examines the received data of serial ID 605 in steps S504 and S505. Specifically, used stamp confirming unit 404 stores and accumulates received data of serial ID 605 in an internal memory such that no overlapping occurs. Used stamp confirming unit 404 checks received serial ID 605 against each of accumulated serial ID 605 to judge if the reproduction stamp corresponding to the received serial ID 605 has already been received and stored. Based on this judgement, the advertiser knows whether the reproduction stamp has already been used.

If the judgement in step S505 indicates that the received reproduction stamp has already been used, “NG” is indicated on display 403 in step S508. Otherwise, “OK” is indicated on display 403 in step S506 and accordingly received contents are stored in step S507. Specifically, the received information for identifying the user and the reproduction stamp are stored in history memory 405 as user identifying information 405A and reproduced data 405B and the received data of serial ID 605 is stored in the internal memory of used stamp confirming unit 404.

If unmatching is found by checking in step S503, “NG” is indicated on display 403 in step S509 and subsequent process steps are not performed.

Suppose that electronic advertisement receiving apparatus 102 is a mobile device. The user may bring electronic advertisement receiving apparatus 102 to a shop of the advertiser. Every time a reproduction stamp is presented by electronic advertisement receiving apparatus 102 which the user brings thereto, the advertiser as the shopkeeper records the number or the like of corresponding serial ID 605 by taking notes or like method. The advertiser may then check if any number of presented serial ID 605 is included in the numbers of serial ID 605 recorded by the notes to find whether the reproduction stamp corresponding to the serial ID has already been used. The user may electronically inform the advertiser of the reproduction stamp, data of serial ID 605 and the like by the short-haul communication system such as IrDA and Bluetooth.

According to the second embodiment, the number of distributed electronic advertisements is limited such that the same electronic advertisement is never distributed to the same user more than once. Therefore, different users can each receive one electronic advertisement.

### Third Embodiment

The third embodiment is hereinafter described. FIG. 12 shows a data structure of an electronic advertisement according to the third embodiment. The third embodiment differs from the first embodiment in that an individual ID 606 and an individual icon information 607 are added as shown in FIG. 12 to the data structure of the electronic advertisement. Individual ID 606 is used for counting points for each individual icon described below. Individual icon information 607 is used for displaying each individual icon as discussed later.

According to the first embodiment, counting of points is managed for each advertisement ID 601. According to the third embodiment, individual ID 606 is added to make it possible, if the advertiser manages a supermarket, that the user can receive points every time the user purchases goods sold at the supermarket, for example.

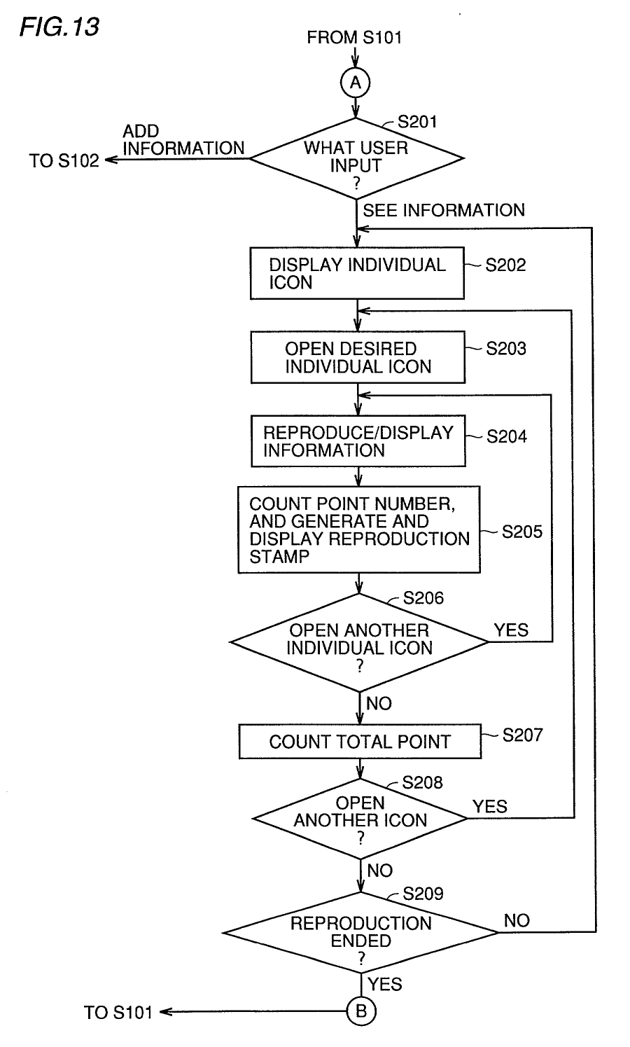

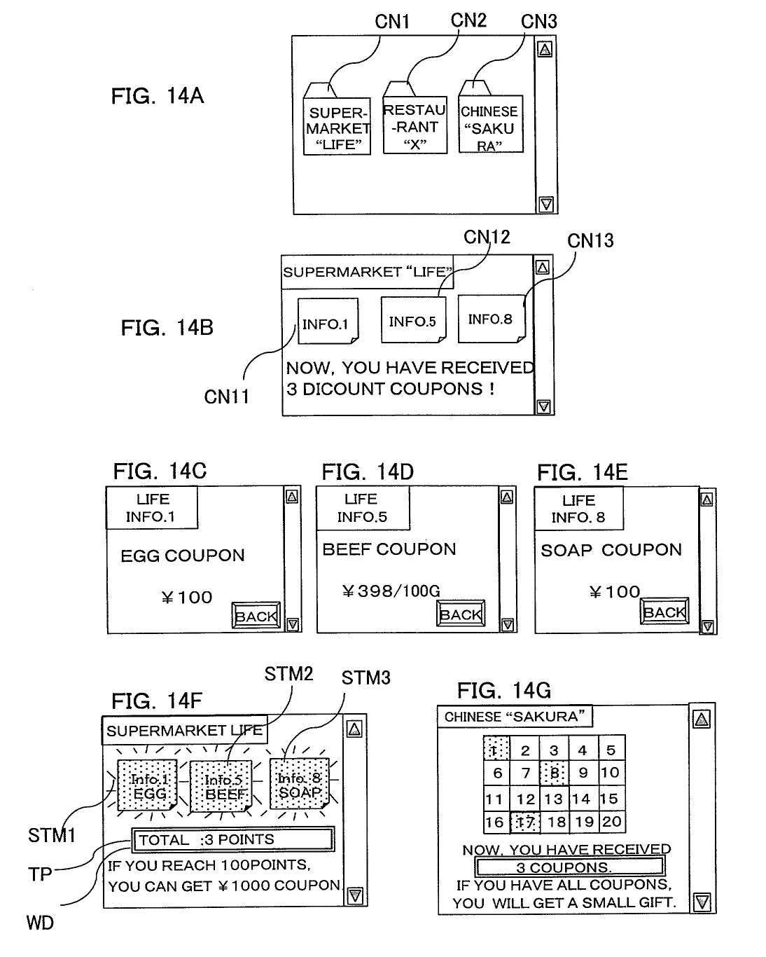

FIG. 13 is a flowchart illustrating a process of generating a reproduction stamp according to the third embodiment. The start and end of the flowchart in FIG. 13 correspond respectively to \mathring{A} and \mathring{B} in FIG. 5 and the same steps as steps S101 to S104 in FIG. 5 are employed in FIG. 13 and description thereof is not repeated here. FIGS. 14A to 14G show examples of display by information output unit 306 according to the third embodiment. A method of reproducing an electronic advertisement by electronic advertisement receiving apparatus 102 in the third embodiment is described below in conjunction with the flowchart in FIG. 13.

In step S201, the user clicks via user input unit 307 an icon of a desired electronic advertisement displayed on information output unit 306 to confirm contents of the electronic advertisement. In step S202, according to individual icon information 607 and application program 604 of the electronic advertisement corresponding to the clicked icon, at least one individual icon is displayed for presenting more detailed information about that electronic advertisement. For example, referring to FIG. 14A, three electronic advertisements are distributed and thus three icons CN1 to CN3 are displayed based on icon information 602 of respective electronic advertisements. When the user manipulates user input unit 307 to select icon CN1 for SUPERMARKET “LIFE” by clicking it, individual icons CN11 to CN13 like “info. 1”corresponding to icon CN1 are displayed as shown in FIG. 14B. Individual icons CN11 to CN13 are displayed based on individual icon information 607 of the corresponding electronic advertisement.

In steps S203, S204 and S205, the user clicks desired one of a plurality of individual icons displayed, ad information corresponding to the clicked individual icon is reproduced based on corresponding ad contents data 603, the number of corresponding points is counted, and a reproduction stamp updated by using the number of counted points is displayed. The expiry date may be defined for these points. In step S206, when another individual icon is clicked as desired one, steps S204 to S206 are followed again in a similar manner. FIGS. 14C to 14E respectively show displayed screens presenting ad information corresponding respectively to individual icons CN11 to CN13 in FIG. 14B.

In step S206, when another individual icon is not clicked, the total points for individual icons counted up according to reproduction of the electronic advertisement is counted in step S207.

After this, in step S208, it is determined whether or not the user clicks a desired one of icons CN1 to CN3 via user input unit 307 that are shown in FIG. 14A. If the desired icon is clicked, step S203 is performed again and subsequent steps are similarly followed. If no desired icon is clicked, steps S202 to S209 are repeated until the user manipulates user input unit 307 to end the reproduction in the step S209.

The above process of reproducing an electronic advertisement is explained now based on examples of display in FIGS. 14A to 14G. In FIG. 14A, icon CN1 is clicked to cause the screen in FIG. 14B to be displayed. Individual icon CN11 of “info.1” is then clicked and accordingly ad information corresponding to individual icon CN11 is displayed according to ad contents data 603 as shown in FIG. 14C. At this time, the reproduction of the electronic advertisement causes the number of points corresponding to individual icon CN11 to be counted up and simultaneously a reproduction stamp for individual icon CN11 is generated by reproduction stamp generating unit 304 based on corresponding individual icon information 607 and the number of counted points. Reproduction stamp STM1 corresponding to individual icon CN11 of “info.1” is accordingly displayed as shown in FIG. 14F. It is noted that FIG. 14F shows a screen displayed after electronic advertisements corresponding to individual icons CN12 and CN13 respectively of “info.5” and “info.8” are reproduced in a similar way (see FIGS. 14D and 14E). As shown, all individual icons CN11 to CN13 are displayed as reproduction stamps STM1 to STM3 respectively and simultaneously data TP indicating the total points corresponding to the number of reproduced individual icons is shown on window WD.

When the value of data TP attains a predetermined value or before the expiry date of the points, the user may be informed of this to be induced to enjoy benefits from the points acquired by electronic advertisement receiving apparatus 102 of the user.

The individual icons may be displayed as shown in FIG. 14G in the form of grid. The screen in FIG. 14G is displayed when icon CN3 in FIG. 14A is clicked to select it. As shown, three individual icons represented respectively by 1, 8 and 17 are selectable. The user can enjoy enhanced visibility by such a display form of individual icons.

According to the third embodiment, the advertiser provides to the user benefits depending on the total points as described above. Therefore, the user would try to receive more electronic advertisements distributed by the advertiser or frequently reproduce them. Consequently, the advertiser can enhance the advertising effects using the electronic advertisements.

### Fourth Embodiment

The fourth embodiment is described now. According to the fourth embodiment, an advertiser can specify, for each user, ad information having contents in which the user would have interest and accordingly present the ad information as an electronic advertisement.

As illustrated according to the embodiments discussed above, when a user transmits a reproduction stamp and information for identifying the user to the advertiser via communication line 212 like the Internet, the advertiser receiving the reproduction stamp produced for each user stores the stamp as reproduced data 405B in history memory 405. The history of reproduced data 405B for that user can accordingly be preserved. The advertiser analyzes reproduced data 405B for each user that is stored in history memory 405. According to contents of any electronic advertisement corresponding to reproduced data 405B that is reproduced by the user numerical times or frequently or reproduced for a long period, the advertiser can specify which ad information the user have interest in. At any later time, the advertiser or ad agency can distribute to the user via communication line 211 or 212 an electronic advertisement that would be reproduced by the user having interest in the contents thereof.

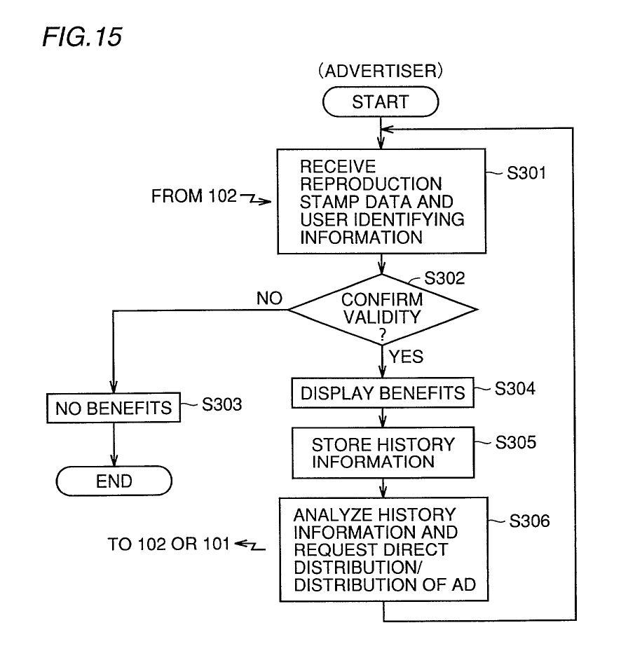

FIG. 15 is a flowchart showing a process by electronic advertisement confirming apparatus 103 according to the fourth embodiment. Following the flowchart in FIG. 15, an operation of electronic advertisement confirming apparatus 103 is described.

In step S301, data receiving unit 401 of electronic advertisement confirming apparatus 103 receives from the user a reproduction stamp representing reproduction of an electronic advertisement as well as information for identifying the user. In step S302, reproduction stamp confirming unit 402 checks the received reproduction stamp against a reproduction stamp informed in advance from the ad agency to ascertain the validity of the received reproduction stamp. If the validity is not confirmed, no information concerning benefits is displayed on display 403 in step S303. As a result, the user cannot enjoy the benefits.

If the validity is ascertained, information on the benefits is shown on display 403 in step S304. Accordingly, the user can receive the benefits as displayed when the user visits a shop of the advertiser. After this, in step S305, reproduced data 405B corresponding to that user is stored as history information in history memory 405 of electronic advertisement confirming apparatus 103. In step S306, the advertiser distributes to the user directly or via the ad agency an electronic advertisement having contents which the user will have interest in. Specifically, the advertiser analyzes reproduced data 405B stored in history memory 405 for each user to specify an electronic advertisement having more detailed contents than those shown by the stored reproduced data 405B or an electronic advertisement having relevant contents and distributes the specified advertisement to the user.

In this way, the user can automatically obtain and confirm, without request, the electronic advertisement with contents in which the user has interest. On the other hand, the advertiser can distribute to each user an electronic advertisement having desired contents for the user and accordingly enhance advertising effects using electronic advertisements.

### Fifth Embodiment

The fifth embodiment is discussed below. According to the fifth embodiment, an advertiser can restrict a distribution area over which electronic advertisements are distributed in order to further enhance advertising effects achieved by the electronic advertisements.

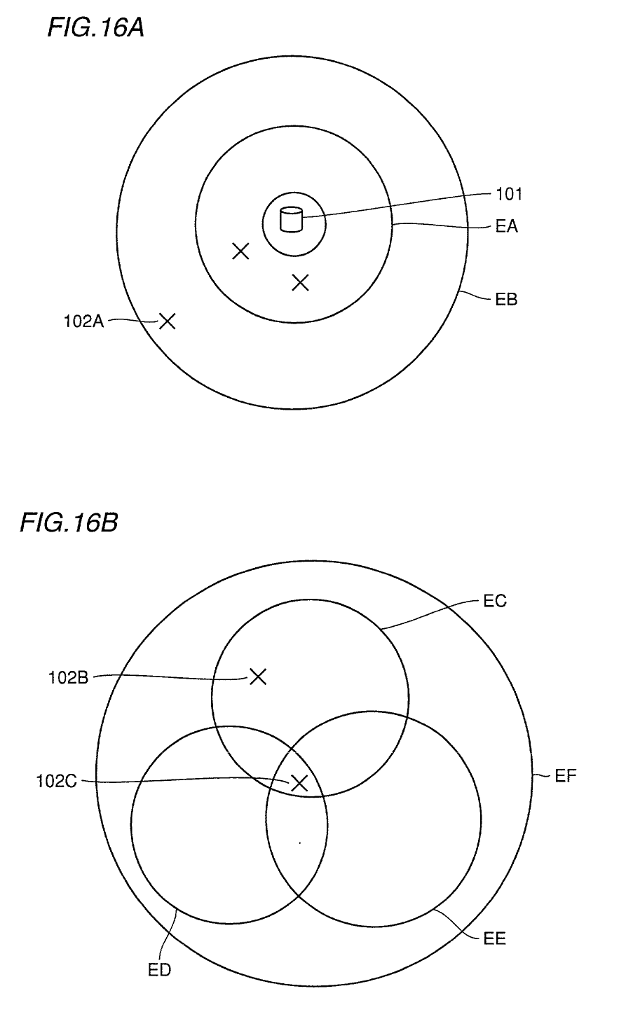

FIGS. 16A and 16B generally show distribution areas of electronic advertisements according to the fifth embodiment. The marking x in the drawings represents electronic advertisement receiving apparatus 102. Referring to FIG. 16A, distribution areas EA and EB different in size are defined depending on the distance from electronic advertisement distribution apparatus 101. When the advertiser asks the ad agency to distribute electronic advertisements, the advertiser can simultaneously designate any of distribution area EA and distribution area EB including distribution area EA. If the advertiser desires to distribute and present electronic advertisements to a user of an electronic advertisement receiving apparatus 102A, the advertiser can designate distribution area EB in FIG. 16A to request the ad agency to distribute the electronic advertisements. On the contrary, if the advertiser desires to distribute electronic advertisements over the range restricted to distribution area EA, the advertiser may designate distribution area EA to ask the ad agency to distribute the electronic advertisements.

Referring to FIG. 16B, distribution areas EC, ED, EE and EF are defined over which electronic advertisements are distributed by electronic advertisement distribution apparatus 101 (not shown). Distribution area EF includes distribution areas EC, ED and EE. Distribution areas EC, ED and EE partially overlap each other. When the advertiser distributes an electronic advertisement to a user of an electronic advertisement receiving apparatus 102C, the advertiser may designate any of distribution areas EC, ED, EE and EF. If the electronic advertisement is distributed to a user of an electronic advertisement receiving apparatus 102B, any of distribution areas EC and EF may be designated. Electronic advertisement receiving apparatus 102B can receive only the electronic advertisements distributed to distribution areas EC and EF. Electronic advertisement receiving apparatus 102C can receive all electronic advertisements distributed to distribution areas EC, ED, EE and EF respectively.

In this way, the advertiser can restrict the distribution area of electronic advertisements, which would be effective when electronic advertisements to be distributed have contents designating any area for example.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic advertisement receiving apparatus for a user receiving advertisement information supplied from an advertiser comprising:
electronic advertisement receiving means for receiving an electronic advertisement including said advertisement information converted into electronic information;
presenting means for presenting to said user said advertisement information of said electronic advertisement received by said electronic advertisement receiving means; and
presentation informing means for informing said advertiser of presentation information representing that said advertisement information of said electronic advertisement has been presented by said presenting means.

2. The electronic advertisement receiving apparatus according to claim 1, wherein
said electronic advertisement further includes identifying information for uniquely identifying the electronic advertisement, and
said electronic advertisement receiving apparatus further comprises:
electronic advertisement storing means for storing at least one said electronic advertisement received by said electronic advertisement receiving means; and
electronic advertisement storage control means for storing said electronic advertisement received by said electronic advertisement receiving means, when said identifying information does not match said identifying information of each of said at least one electronic advertisement stored in said electronic advertisement storing means, in said electronic advertisement storing means.

3. The electronic advertisement receiving apparatus according to claim 1, further comprising presentation information output means for outputting said presentation information to said user, wherein
said presentation information includes benefit information representing benefits supplied from said advertiser to said user in return for presentation of said advertisement information of corresponding said electronic advertisement.

4. The electronic advertisement receiving apparatus according to claim 3, wherein
said benefits are updated according to the number of times or a time period said advertisement information of said corresponding electronic advertisement is presented.

5. The electronic advertisement receiving apparatus according to claim 3, wherein
said electronic advertisement further includes procedure information representing a procedure for generating said presentation information while updating said benefits, and
said electronic advertisement receiving apparatus further comprises presentation information generating means for generating said presentation information while updating said benefits according to said procedure information of said electronic advertisement received by said electronic advertisement receiving means.

6. An electronic advertisement confirming apparatus for an advertiser comprising:
electronic advertisement supply means for supplying to a user an electronic advertisement including advertisement information converted into electronic information;
presentation information receiving means for receiving from said user supplied with said electronic advertisement from said electronic advertisement supply means presentation information representing that said advertisement information of said electronic advertisement has been presented to said user; and
presentation information output means for outputting said presentation information received by said presentation information receiving means.

7. The electronic advertisement confirming apparatus according to claim 6, further comprising validity confirming means for confirming validity of said presentation information received by said presentation information receiving means, wherein
said presentation information includes benefit information representing benefits supplied from said advertiser to said user in return for presentation of said advertisement information of corresponding said electronic advertisement.

8. The electronic advertisement confirming apparatus according to claim 7, further comprising:
presentation information storing means for storing for each said user said presentation information with validity confirmed by said validity confirming means; and
analyzed electronic advertisement supply means for analyzing for each said user said advertisement information corresponding to said presentation information stored in said presentation information storing means to supply to said user via said electronic advertisement supply means said electronic advertisement corresponding to said advertisement information having contents reflecting the analysis.

9. The electronic advertisement confirming apparatus according claim 8, wherein
a plurality of said electronic advertisements corresponding to said advertisement information having the same contents are supplied to different said users and further include respective pieces of identifying information for uniquely identifying said electronic advertisements, and
said pieces of identifying information corresponding to respective pieces of presentation information stored in said presentation information storing means are different from each other.

10. An electronic advertisement supply system comprising an electronic advertisement distribution apparatus distributing an electronic advertisement including advertisement information corresponding to an advertiser, said advertisement information converted into electronic information, and comprising an electronic advertisement receiving apparatus receiving said electronic advertisement and presenting said electronic advertisement to a user,
said electronic advertisement distribution apparatus including electronic advertisement transmitting means for transmitting said electronic advertisement corresponding to said advertisement information requested by said advertiser to be distributed, said electronic advertisement transmitted together with an identifier for uniquely identifying said electronic advertisement, and
said electronic advertisement receiving apparatus including response data transmitting means for generating, when said electronic advertisement is transmitted from said electronic advertisement transmitting means and received, response data representing reception of said electronic advertisement based on said identifier received together with said received electronic advertisement and transmitting the generated response data to said electronic advertisement distribution apparatus.

11. The electronic advertisement supply system according to claim 10, wherein
said electronic advertisement distribution apparatus further includes
response data receiving means for receiving said response data transmitted from said response data transmitting means and
distribution ending means calculating the number of distributed electronic advertisements based on said response data received by said response data receiving means for ending distribution of said electronic advertisements when the calculated number reaches a predetermined number.

12. The electronic advertisement supply system according to claim 10, wherein
said electronic advertisement distribution apparatus distributes said electronic advertisement to a limited area.

13. The electronic advertisement supply system according to claim 10, further comprising an electronic advertisement confirming apparatus for said advertiser, wherein
said electronic advertisement confirming apparatus includes
electronic advertisement distribution request means for requesting said electronic advertisement distribution apparatus to distribute said electronic advertisement,
presentation information receiving means for receiving from said user receiving said distributed electronic advertisement presentation information representing presentation of said electronic advertisement to the user, and
presentation information output means for outputting said presentation information received by said presentation information receiving means.

14. The electronic advertisement supply system according to claim 13, wherein
said electronic advertisement confirming apparatus further includes presentation information storing means for storing for each said user said presentation information received by said presentation information receiving means, and
said advertisement information corresponding to said presentation information stored in said presentation information storing means is analyzed for each user and said electronic advertisement corresponding to said advertisement information having contents reflecting the analysis is distributed to the user via said electronic advertisement distribution request means.

15. The electronic advertisement supply system according to claim 13, wherein
said presentation information includes benefit information representing benefits supplied from said advertiser to said user in return for presentation of said advertisement information of corresponding said electronic advertisement.
